(19) United States
(12) Patent Application Publication
(10) Pub. No.: US 2016/0362035 A1
(43) Pub. Date: Dec. 15, 2016

(54) SILO TRANSPORTATION SYSTEM

(71) Applicant: Lake Truck Lines, Inc., San Antonio, TX (US)

(72) Inventors: Douglas S. Cain, San Antonio, TX (US); Jose Antonio Medina, Torreon (MX)

(21) Appl. No.: 14/738,614

(22) Filed: Jun. 12, 2015

(51) Int. Cl. B60P 1/32; B60P 3/00; B60P 1/16; B65G 67/04; B60P 1/36

(52) U.S. Cl. CPC B60P 1/32; B65G 67/04; B60P 1/36; B60P 1/16; B60P 3/00

(57) ABSTRACT

A silo transportation system is described that can load, transport, and unload at least one silo. For example, the silo transportation system can load a silo onto a flatbed frame at a first location, transport the silo on the flatbed frame to a second location, and then unload the silo at the second location.

### TECHNICAL FIELD

The subject matter described herein relates to a transportation system that is configured to load, transport, and unload at least one silo.

### BACKGROUND

A silo can have a variety of uses, such as for storing materials in bulk. Even when empty, silos can be heavy and difficult to move. For example, in order to move a silo, a crane can be used to load a silo onto a transportation vehicle at a first location. The transportation vehicle can then move the silo to a second location where another crane can assist with unloading the silo from the transportation vehicle. As such, a lot of manpower and machinery can be needed simply for moving a silo.

### SUMMARY

Aspects of the current subject matter include a silo transportation system that is configured to load, transport, and unload at least one silo. In one aspect, a silo transportation system is described that includes a mobile flatbed frame having a conveyor mechanism configured to secure a first silo to the mobile flatbed frame and position the first silo along a top surface of the mobile flatbed frame. In addition, the silo transportation system can include a tower configured to releasably couple the first silo to the mobile flatbed frame for at least one of loading the first silo onto the mobile flatbed frame and unloading the first silo from the mobile flatbed frame. The tower can be pivotally secured to the mobile flatbed frame at a first end thereby allowing the tower to form a first position and a second position, with the first position including the tower being parallel to the mobile flatbed frame and the second position including the tower being substantially perpendicular to the mobile flatbed frame. Additionally, the silo transportation system can include a tower positioning mechanism for moving the tower from the first position to the second position.

In some variations one or more of the following features can optionally be included in any feasible combination. The tower positioning mechanism can include one or more of a telescoping cylinder, a gear and a pulley. The tower can include a movable attachment feature that is configured to engage the first silo and form a first loading position and a second loading position, the first loading position allowing a base of the first silo to be in contact with a ground support and the second loading position having the base of the first silo separated from the ground support. In addition, the distance can be within a range of one inch to one foot. Furthermore, the movable attachment feature can include a hook that is hydraulically controlled.

The silo transportation system can further include one or more stabilizers configured to stabilize at least the mobile flatbed frame. The stabilizers can be hydraulically controlled and positioned adjacent a back end of the mobile flatbed frame. The conveyor mechanism can include a chain drive that is configured to move along a length of the mobile flatbed frame. The conveyor mechanism can include a connector that is coupled to the chain drive and is configured to releasably connect to the first silo. The silo transportation system can further include a hitch mechanism that is configured to couple the mobile flatbed frame to a vehicle. The mobile flatbed frame is configured to store a second silo adjacent the first silo.

In another interrelated aspect of the current subject matter, a method includes positioning a tower of a silo transportation system in a second position adjacent a first silo, wherein the second position includes the tower being substantially perpendicular to a mobile flatbed frame of the silo transportation system. In addition, the method can include engaging a moveable attachment feature of the tower with the first silo for releasably securing the first silo to the tower. Additionally, the method can include moving the movable attachment feature a distance along the tower thereby causing a base of the first silo to separate from a ground support by the distance. Furthermore, the method can include pivoting the tower into a first position, wherein the first position includes the tower being parallel to the mobile flatbed frame, the tower being pivotally secured to the mobile flatbed frame at a first end. The method can also include releasing the moveable attachment feature from the first silo and securing the first silo to a conveyor mechanism of the silo transportation system, the conveyor mechanism being configured to secure the first silo to the mobile flatbed frame and position the first silo along a top surface of the mobile flatbed frame. The method can also include activating the conveyor mechanism to move the first silo into a storage position for transporting the first silo.

In some variations, the releasing can include retracting the moveable attachment feature towards the tower and the securing can include coupling a connector of the conveyor mechanism to the first silo, with the connector being secured to a chain drive of the conveyor mechanism that is configured to move along a length of the mobile flatbed frame. The activating can include moving the chain drive along the length of the mobile flatbed frame. In addition, in some variations, the method can include pivoting the tower into the second position, positioning the tower adjacent a second silo, and engaging the moveable attachment feature of the tower with the second silo for releasably securing the second silo to the tower. Additionally, the method can include moving the movable attachment feature the distance along the tower thereby causing a second base of the second silo to separate from the ground support and pivoting the tower into the first position.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a side view illustrating features of a silo transportation system including a tower and flatbed frame with the tower in a first position;

FIG. 2 shows the silo transportation system of FIG. 1 with the tower in a second position;

FIG. 3 shows a diagram illustrating a perspective top view of an implementation of the tower;

FIG. 4 shows a diagram illustrating a perspective top view of an implementation of a moveable attachment feature of the tower;

FIG. 5 shows a diagram illustrating a perspective top view of an implementation of a part of the conveyor mechanism of the flatbed frame;

FIGS. 6-10 illustrate an example of loading a first silo onto the flatbed frame of the silo transportation system of FIG. 1;

FIGS. 11-12 illustrate an example of loading a second silo onto the flatbed frame of the silo transportation system of FIG. 1; and

FIG. 13 shows a process flow diagram illustrating aspects of a method having one or more features consistent with implementations of the current subject matter.

When practical, similar reference numbers denote similar structures, features, or elements.

### DETAILED DESCRIPTION

The current subject matter is directed to a silo transportation system that can load a silo onto the silo transportation system, transport the silo from one location to another location, and unload the silo from the silo transportation system. As such, the silo transportation system can accomplish what has required more than one system and operator to accomplish. For example, a first crane may have been used to load the silo onto a vehicle that can transport the silo, and then a second crane to unload the silo off of the vehicle. In contrast, with the silo transportation system disclosed herein, the loading, transportation and the unloading of a silo can all be advantageously done using the silo transportation system and a single operator. Furthermore, although the silo transportation system is generally described herein as loading, transporting, and unloading a single silo, the silo transportation system can be configured to load, transport and unload more than one silo, such as two silos.

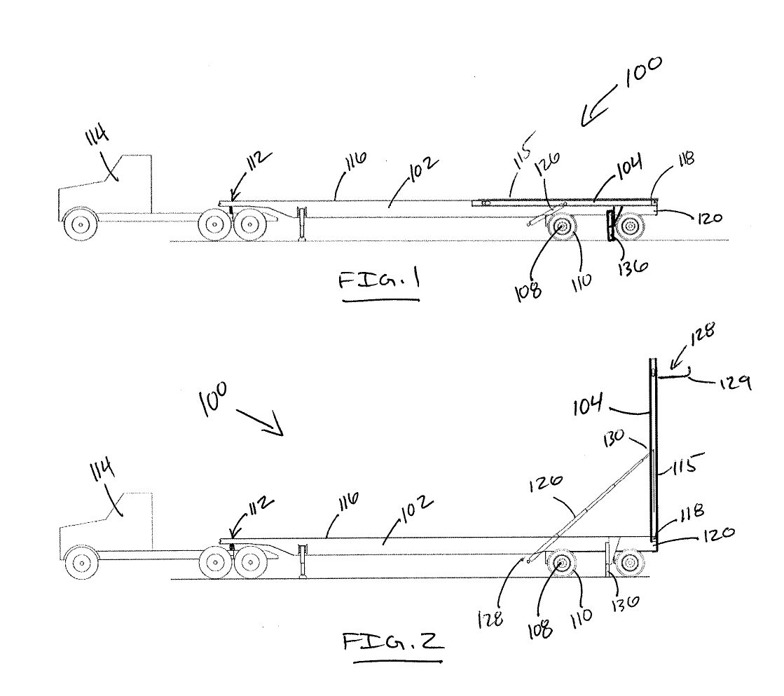

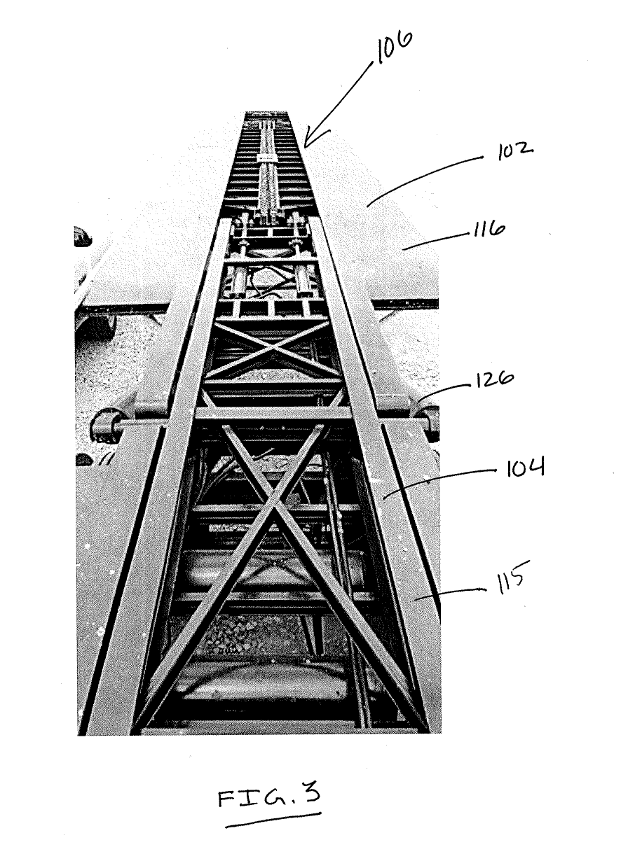

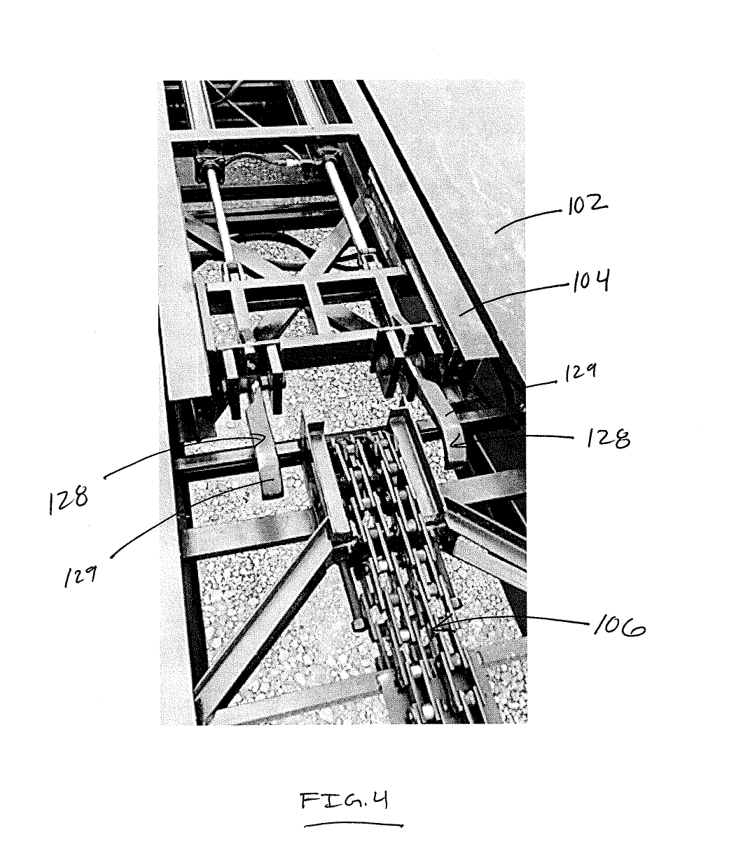

FIGS. 1-2 illustrate a silo transportation system 100 that includes a flatbed frame 102 and a tower 104 that is pivotally secured to the flatbed frame 102. The tower 104 can assist with loading and unloading a silo from the flatbed frame 102. The flatbed frame 102 can include a conveyor mechanism 106 (as shown in FIG. 3) that can assist with positioning the silo along the flatbed frame 102, such as once the silo has been loaded onto the flatbed frame 102. The flatbed frame 102 can include an axle 108 that is coupled to one or more wheels 110, which can assist with transporting any silos that are secured to the flatbed frame 102. For example, the flatbed frame 102 can include two axles 108, with each axle coupled to a pair of wheels 110. The flatbed frame 102 can also include suspension airbags and/or a hitch mechanism 112 that is configured to couple the flatbed frame 102 to a vehicle 114, such as a tractor. The hitch mechanism 112 can allow the flatbed frame 102 to be releasably coupled to a variety of vehicles. In some implementations, the flatbed frame 102 can be integrated with a vehicle such that a hitch mechanism is not needed.

The flatbed frame 102 can be elongated and have a generally flat top surface 116 that can allow a silo to travel along the top surface 116. For example, a silo that has been loaded onto the top surface 116 of the flatbed frame 102 can be moved along the top surface 116 by the conveyor mechanism 160, such as in order to position the silo for transportation or unloading, as will be discussed in greater detail below.

As mentioned above, the tower 104 can assist with loading a silo onto the flatbed frame 102 as well as unloading the silo from the flatbed frame 102. In some implementations, a first end 118 of the tower 104 can be pivotally secured at a back end 120 of the flatbed frame 102, which can allow the tower 104 to form at least a first position and a second position relative to the flatbed frame 102. In the first position, the tower 104 can be parallel to the flatbed frame 102, as shown in FIG. 1, and in the second position, the tower 104 can be substantially perpendicular to the flatbed frame 102, as shown in FIG. 2. For example, the second position of the tower 104 can be substantially perpendicular such that the tower 104 is close enough to vertical that the silo can settle in an upright position once placed on a ground support.

In addition, one or more tower positioning mechanisms can assist with moving the tower for loading and unloading silos. For example, telescoping cylinders 126 can be secured at a first telescoping end 128 to the flatbed frame 102 and secured at a second telescoping end 130 to the tower 104. The telescoping cylinders 126 can expand and collapse, thereby pivoting the tower 104 relative to the flatbed frame 102. For example, when the telescoping cylinders 126 are in a collapsed configuration, the tower 104 can be in the first position. In addition, when the telescoping cylinders 126 are in an expanded configuration, the tower 104 can be in the second position. The telescoping cylinders 126 can be controlled in a variety of ways, including hydraulically, pneumatically, mechanically, electrically, or any other way that allows the telescoping cylinders 126 to move the tower 104 into at least the first and second position. In addition, although the silo transportation system 100 is shown as having a pair of telescoping cylinders 126, any number of a variety of tower positioning mechanisms that can move the tower 104 into at least the first and second position is within the scope of this disclosure. For example, the tower positioning mechanism can include one or more of a gear or pulley.

In some implementations, the silo transportation system 100 can include a single fuel engine that can operate a main hydraulic pump. The main hydraulic pump can actuate a hydraulic motor and any hydraulic cylinders within the silo transportation system 100, such as the telescoping cylinders.

FIG. 3 shows a part of the tower 104 in the first position. The tower 104 can be elongated in shape and include either a solid platform or a cross-bar structure, as shown in FIG. 3. The flatbed frame 102 can include a recess or opening along a length of the flatbed frame 102 that can allow a front side 115 of the tower 104 to lay flush with the top surface 116 of the flatbed frame 102 when the tower 104 is in the first position.

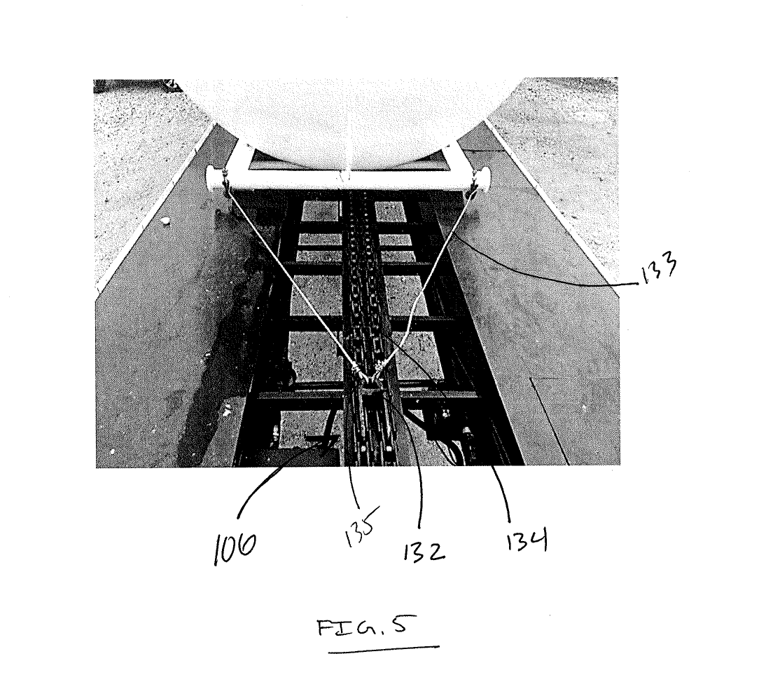

As shown in FIG. 4, the tower 104 can include a moveable attachment feature 128 that can engage a part of a silo and assist with loading and unloading the silo. For example, the moveable attachment feature 128 can releasably engage the silo in order to couple the silo to the tower 104, which can then allow the tower 104 to load the silo onto the flatbed frame. The moveable attachment feature 128 can include one or more of a variety of features that assist with securing the silo to the tower 104.

As shown in FIG. 4, the moveable attachment feature 128 can include a pair of retractable hooks 129 that can engage a part of the silo. For example, the retractable hooks 129 can form a retracted position where the retractable hooks 129 lie flush or below the front side 115 of the tower 104. In the retracted position, the retractable hooks 129 can allow a silo to slide along the front side 115 of the tower 104, such as when the silo is being moved by the conveyor mechanism 106, as will be discussed in greater detail below. In addition, the retractable hooks 129 can form an extended position (as shown in FIG. 2), which can allow the retractable hooks 129 to extend from the front side 115 of the tower 104 and engage a part of the silo. Although shown as a pair of retractable hooks, the moveable attachment features 128 can include one or more of a variety of features that can releasably secure at least one silo to the tower 104.

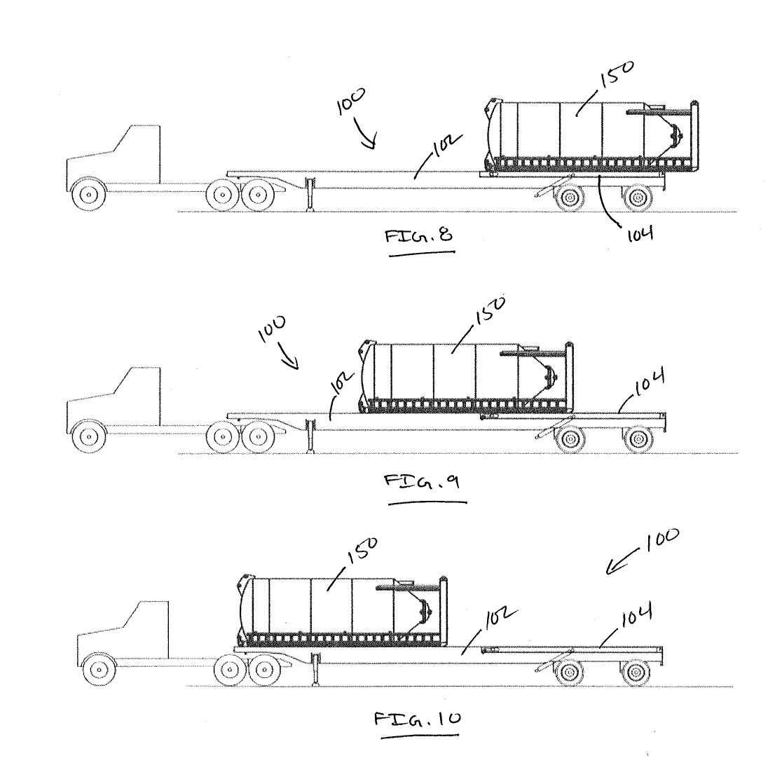

In some implementations, the moveable attachment feature 128 can also move from at least a first loading position to a second loading position. In the first loading position, for example, the moveable attachment feature 128 can allow a base of the silo to rest on a ground support, as shown in FIG. 6. In the second loading position, the moveable attachment feature 128 can be located a distance from the first loading position along the tower 104, which can thereby lift the silo from the ground support. For example, the moveable attachment feature 128 can move approximately 1 in. to approximately 1 ft. along the tower 104 (i.e., the distance between the first and second loading position), which can thereby lift the silo approximately 1 in. to approximately 1 ft. from the ground support. Lifting the silo from the ground support can allow the tower 104 to pivot into the first position where the tower 104 is parallel to the flatbed frame 102 without the base of the silo scraping the ground support or interfering with the tower's ability to pivot.

Once the tower 104 is in the first position with the silo attached to the tower 104, the moveable attachment features 128 can retract in order to allow the silo to be moved along the length of the flatbed frame 102, such as by the conveyor mechanism 106. In some implementations, prior to retracting, the moveable attachment features 128 can further advance along the tower 104, thereby pushing the silo in a direction. As such, the moveable attachment features 128 can push the silo along the front side 115 of the tower 104 in order to position the silo for coupling to the conveyor mechanism 106.

In addition, during unloading of the silo, the moveable attachment feature 128 can extend from the tower 104 and form the extended configuration in order to be positioned to secure the silo to the tower 104 as the tower 104 pivots to the second position. The moveable attachment features 128 can also descend along the tower 104, such as from the second loading position to the first loading position, in order to place the base of the silo onto the ground support once the. Movement of the moveable attachment features 128 (i.e., for lifting/lowering the silo and/or moving the moveable attachment features 128 between an extended and retracted position) can be controlled using one or more of a variety of mechanisms, including hydraulic, mechanical, electrical, etc. For example, a pair of hydraulic cylinders can actuate the moveable attachment features 128, which can assist with moving or lifting the silo from the ground support and placing the silo at a variety of lifted positions or heights.

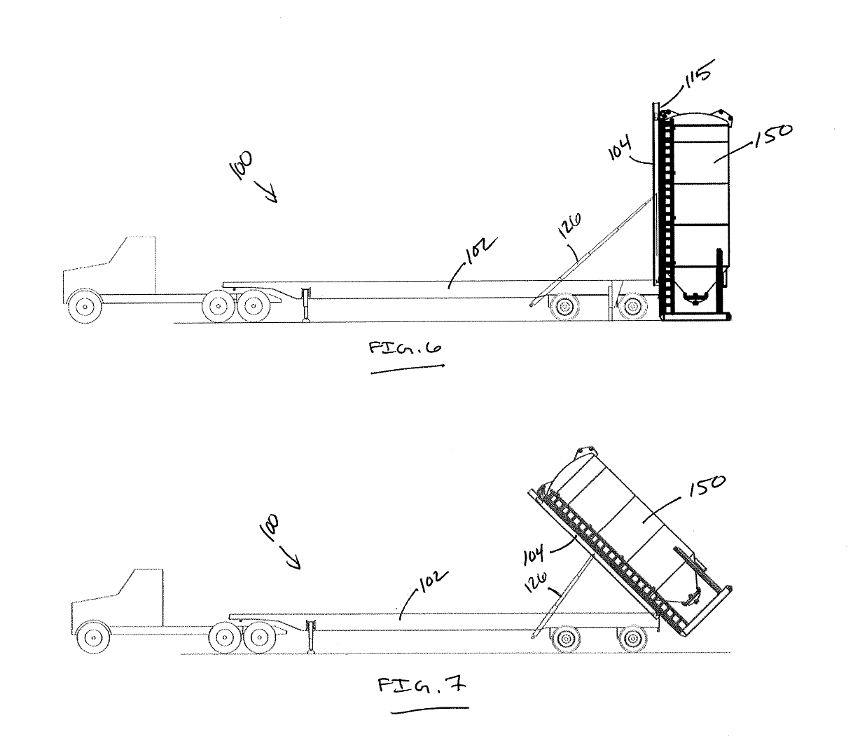

FIG. 5 shows an implementation of the conveyor mechanism 106, which can extend along a length of the flatbed frame 102 and assist with moving at least one silo along the flatbed frame 102. The conveyor mechanism 106 can include a connector 132 that can releasably connect to a part of a silo, such as either a top or bottom part of the silo. In some implementations, the connector 132 can include one or more cables 133 that extend from a link 135 that is secured to a part of the conveyor mechanism 106 that travels along the flatbed frame 102, such as a chain drive 134, as shown in FIG. 5. Once the connector 132 is connected to the silo and the conveyor mechanism 106 is activated, the connector 132 can pull the silo in a direction along the top surface 116 of the flatbed frame 102.

For example, as shown in FIG. 5, the conveyor mechanism 106 can include a chain drive 134 that extends along a length of the flatbed frame 102. In some implementations, the chain drive 134 can include a pair of chains, which can include one or more skid lock claps that can assist with moving or sliding a silo into place. The conveyor mechanism 106 can be controlled by a variety of mechanisms, such as a hydraulic or electric motor. In some implementations, the conveyor mechanism can include one or more cables, bars, and/or dragging pates that can assist with moving a silo along the top surface 116 of the flatbed frame 102. In addition, the conveyor mechanism 106 can include a parallel chain conveyor that can move along a length of the flatbed frame 102 towards either the front end or back end of the flatbed frame. Additionally, a hydraulic motor can control the speed and/or direction of movement of the parallel chain conveyor or chain drive 134.

When the conveyor mechanism is activated, for example, the chain drive 134 can move in a direction along the length of the flatbed frame 102, such as towards a front end or back end of the flatbed frame 102. As such, a silo that is connected to the connector 132 can be pulled by the connector 132 in the direction the chain drive 134 is advancing. Therefore, the movement of the chain drive 134, and the connection of the connector 132 to the silo, can allow the silo to be positioned in a variety of locations along the top surface 116 of the flatbed frame 102.

In addition, when the tower 104 forms the first position with a silo attached to the front side 115 of the tower 104, the connector 132 can be coupled to the silo, along with activation of the conveyor mechanism 106, in order to slide the silo off of the front side 115 of the tower 104 and position the silo adjacent a front end of the flatbed frame 102. For example, this can allow the tower 104 to return to the second position and secure another silo to the tower 104 for loading onto the flatbed frame 102. Furthermore, during unloading of a silo, the conveyor mechanism 106 can be used to position the silo in place over the tower 104 in order to allow the tower 104 to engage the silo (such as with the moveable attachment features 128) and move into the second position for unloading the silo onto a ground support.

The flatbed frame 104 can also include one or more stabilizers 136 that can assist with stabilizing the flatbed frame 102, such as when the flatbed frame 12 is not moving. For example, the stabilizers 136 can provide additional support when a silo is being loaded onto or unloaded from the flatbed frame 102. In some implementations, the one or more stabilizers 136 can be hydraulically controlled and/or positioned adjacent the back end 120 of the flatbed frame 102. However, the stabilizers 136 can be controlled in any number of ways, such as mechanically, pneumatically, etc. Furthermore, the stabilizers 136 can be independently controlled, which can, for example, allow for improved stabilization along uneven ground. The stabilizers 136 can also assist with adjusting the height of the flatbed frame 102.

FIGS. 6-10 show an example of loading a first silo onto a flatbed frame 102. As shown in FIG. 6, the tower 104 can be positioned in the second position with a front side 115 of the tower 104 located adjacent a first silo 150 that is positioned on a ground support. A pair of moveable attachment features 128 can extend from the tower 104 in an extended position and engage a part of the first silo 150, such as a cross-bar or support beam of the first silo 150. The moveable attachment features 128 can move a distance along the tower 104 into a second loading position, which can lift the first silo 150 from the ground support (e.g., approximately 1 in. to approximately 1 ft.). Once the moveable attachment feature 128 is in the second loading position, the telescoping cylinders 126 can move into a collapsed configuration thereby moving the tower 104 into the first position, as shown in FIGS. 7 and 8.

In some implementations, any suspension airbags of the silo transportation system 100 can be deflated and an engine (e.g., fuel engine that controls hydraulic pump) that controls one or more features of the silo transportation system 100 can be activated prior to loading any silos. In addition, one or more stabilizers 136 can be extended prior to loading any silos in order to allow the one or more stabilizers 136 to provide additional support during loading.

When the tower 104 is in the first position with the first silo 150 attached to the front side 115 of the tower 104, the moveable attachment features 128 can be retracted and the connector 132 of the conveyor mechanism 106 can be secured to a part of the first silo 150, such as the top of the first silo 150. In addition, prior to retracting, the moveable attachment features 128 can also move the first silo 150 along the tower 104 in order to better position the first silo 150 for connecting to the conveyor mechanism 106. The conveyor mechanism 106 can be activated such that the drive chain 134 is caused to advance toward the front end of the flatbed frame 102. As a result, the connector 132 can pull the first silo 150 toward the front end of the flatbed frame 102, as shown in FIG. 9. The conveyor mechanism 106 can continue to pull the first silo 150 toward the front end of the flatbed frame 102 until the first silo 150 has at least been removed from the tower 104, including having an end of the first silo 150 positioned adjacent the front end of the flatbed frame 102, such as in FIG. 10. Once the first silo 150 has been removed from the tower 104, the tower 104 can be free to begin loading another silo.

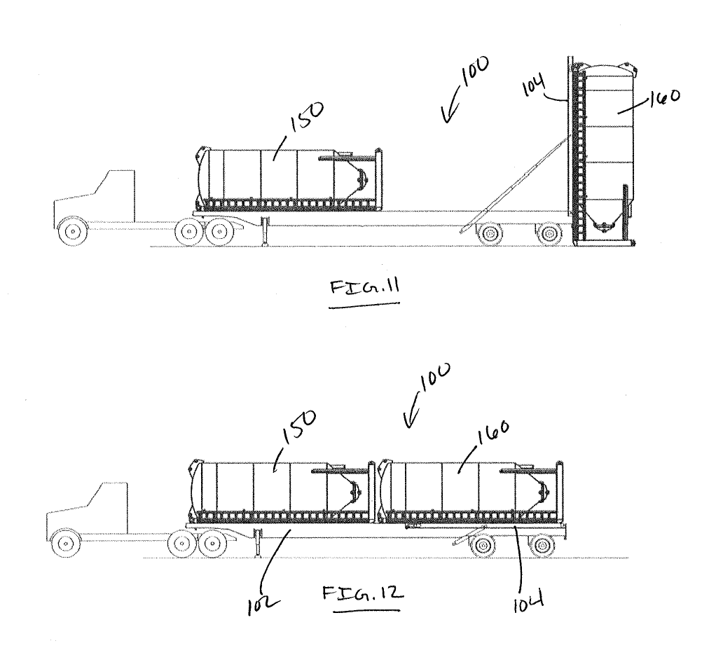

FIGS. 11-12 show the silo transportation system 100 loading a second silo 160 onto the flatbed frame 102. Similar to the first silo 150, the tower 104 can be placed in the second position, positioned adjacent the second silo 160, and loaded onto the flatbed frame 102 in the same or similar manner as was done for the first silo 150. However, once the tower 104 has been placed into the first position, as shown in FIG. 12, the second silo 160 can either stay positioned along the tower 104, or the second silo 160 can be moved along the top surface of the flatbed frame 102, such as by connecting the connector 132 to the second silo 160 and activating the conveyor mechanism 106.

In addition, the silo transportation system can unload one or more silos. For example, the silo transportation system 100 can unload the first silo 150 and second silo 160, with the second silo 160 being unloaded first. In addition, the first silo 150 and second silo 160 can be unloaded in a reverse order from which they were loaded.

For example, in order to unload the second silo 160, the moveable engagement features 128 can form an extended position and the tower 104 can move into the second position as a result of the telescoping cylinders 126 forming an expanded configuration. Once the tower 104 is in the second position, the moveable attachment features 128 can descend down the tower 104 into the first loading position, which can allow the base of the second silo 160 to rest on the ground support. The moveable attachment features 128 can then disengage the second silo 160, such as by further descending along the tower 104, and form the retracted position. The tower 104 can then return to the first position, thereby allowing the first silo 150 to be loaded onto the tower 104 for subsequent unloading. The first silo 150 can be connected to the connector 132 and, upon activation of the conveyor mechanism 106, pull the first silo 150 onto the tower 104. Once the first silo 150 is positioned on the tower 104, the moveable attachment features 128 can form the extended position in order to releasably couple the first silo 150 to the tower 104, such as when the tower 104 moves into the second position and as the moveable attachment features 128 descend down the tower 104 in order to allow the base of the first silo 150 to be placed on the ground support. Once the first silo 150 is unloaded (i.e., the base of the first silo 150) is placed on the ground support), the moveable attachment features 128 can be retracted and the tower 104 returned to the first position.

Although the silo transportation system shown and described herein is configured to load, transport, and unload two silos, the silo transportation system can be configured to load, transport, and unload one or more silos. Furthermore, the silos can be in an upright position or laying on their side when loaded onto the silo transportation system. In addition, the silos can be unloaded such that they are positioned in either an upright position or laid down along a side. Therefore, although the silos are shown herein as positioned upright when initially loaded and unloaded, and shown laying on a side when being transported, the silos can be loaded, unloaded and transported in any number of positions and orientations. In addition, the silos can vary in shape and/or size. For example, a length of a silo can be within a range of approximately 5 ft. to approximately 30 ft. Some silos can have a capacity, for example, from approximately 500 cuft to approximately 1200 cuft.

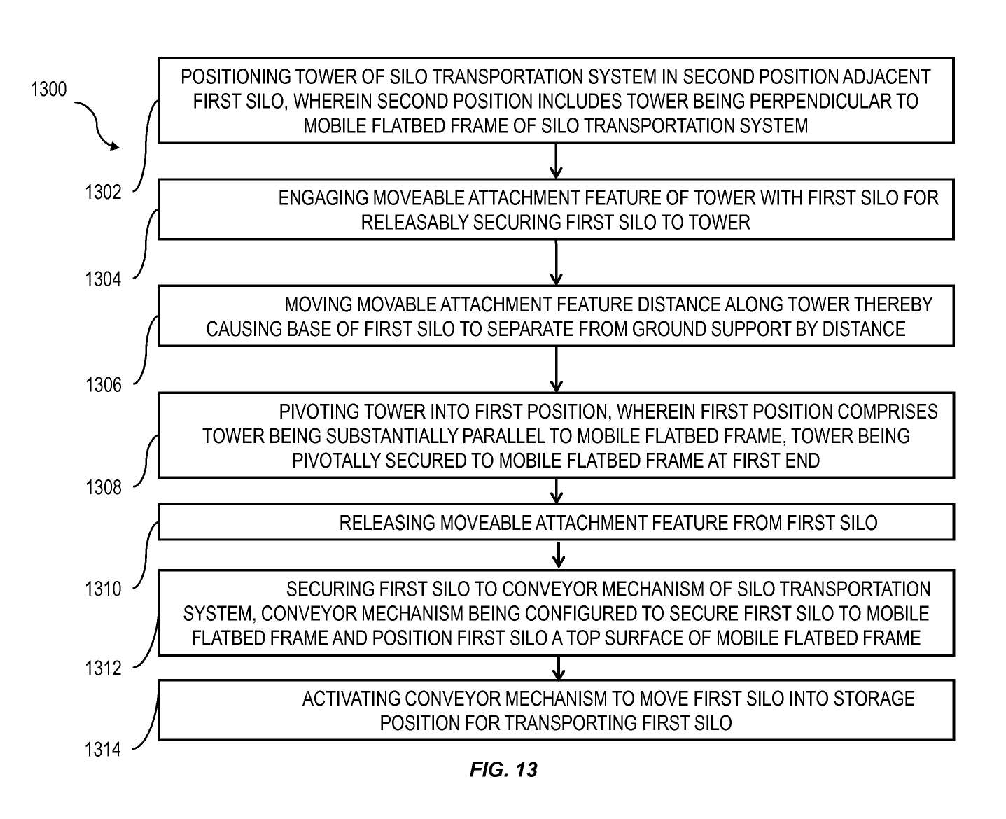

FIG. 13 shows a process flow chart 1300 illustrating features of a method consistent with one or more implementations of the current subject matter. It will be understood that other implementations may include or exclude certain features. At 1302, a tower of a silo transportation system can be positioned in a second position adjacent a first silo. The second position can include the tower being substantially perpendicular to a mobile flatbed frame of the silo transportation system. At 1304, a moveable attachment feature of the tower can be engaged with the first silo for releasably securing the first silo to the tower. At 1306, the movable attachment feature can move a distance along the tower thereby causing a base of the first silo to separate from a ground support. At 1308, the tower can pivot into a first position, wherein the first position includes the tower being parallel to the mobile flatbed frame. The tower being pivotally secured to the mobile flatbed frame at a first end. At 1310, the moveable attachment feature can be released from the first silo. At 1312, the conveyor mechanism of the silo transportation system can be secured to the first silo. The conveyor mechanism can be configured to secure the first silo to the mobile flatbed frame and position the first silo along a top surface of the mobile flatbed frame. In addition, at 1314, the conveyor mechanism can be activated in order to move the first silo into a storage position for transporting the first silo.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A silo transportation system comprising:
a mobile flatbed frame having a conveyor mechanism configured to secure a first silo to the mobile flatbed frame and position the first silo along a top surface of the mobile flatbed frame;
a tower configured to releasably couple the first silo to the mobile flatbed frame for at least one of loading the first silo onto the mobile flatbed frame and unloading the first silo from the mobile flatbed frame, the tower being pivotally secured to the mobile flatbed frame at a first end thereby allowing the tower to form a first position and a second position, with the first position including the tower being parallel to the mobile flatbed frame and the second position including the tower being substantially perpendicular to the mobile flatbed frame; and
a tower positioning mechanism for moving the tower from the first position to the second position.

2. The silo transportation system of claim 1, wherein the tower positioning mechanism comprises one or more of a telescoping cylinder, a gear and a pulley.

3. The silo transportation system of claim 1 wherein the tower comprises a movable attachment feature that is configured to engage the first silo and form a first loading position and a second loading position, the first loading position allowing a base of the first silo to be in contact with a ground support and the second loading position having the base of the first silo separated from the ground support.

4. The silo transportation system of claim 3, wherein the distance is within a range of one inch to one foot.

5. The silo transportation system of claim 3, wherein the movable attachment feature comprises a hook that is hydraulically controlled.

6. The silo transportation system of claim 1, wherein the silo transportation system further comprises one or more stabilizers configured to stabilize at least the mobile flatbed frame.

7. The silo transportation system of claim 6, wherein the stabilizers are hydraulically controlled and positioned adjacent a back end of the mobile flatbed frame.

8. The silo transportation system of claim 1, wherein the conveyor mechanism comprises a chain drive that is configured to move along a length of the mobile flatbed frame.

9. The silo transportation system of claim 8, wherein the conveyor mechanism comprises a connector that is coupled to the chain drive and is configured to releasably connect to the first silo.

10. The silo transportation system of claim 1, further comprising a hitch mechanism that is configured to couple the mobile flatbed frame to a vehicle.

11. The silo transportation system of claim 1, wherein the mobile flatbed frame is configured to store a second silo adjacent the first silo.

12. A method comprising:
positioning a tower of a silo transportation system in a second position adjacent a first silo, wherein the second position includes the tower being substantially perpendicular to a mobile flatbed frame of the silo transportation system;
engaging a moveable attachment feature of the tower with the first silo for releasably securing the first silo to the tower;
moving the movable attachment feature a distance along the tower thereby causing a base of the first silo to separate from a ground support by the distance;
pivoting the tower into a first position, wherein the first position comprises the tower being parallel to the mobile flatbed frame, the tower being pivotally secured to the mobile flatbed frame at a first end;
releasing the moveable attachment feature from the first silo;
securing the first silo to a conveyor mechanism of the silo transportation system, the conveyor mechanism being configured to secure the first silo to the mobile flatbed frame and position the first silo along a top surface of the mobile flatbed frame; and
activating the conveyor mechanism to move the first silo into a storage position for transporting the first silo.

13. The method of claim 12, wherein the movable attachment feature comprises a hook that is hydraulically controlled.

14. The method of claim 12, wherein the releasing comprises retracting the moveable attachment feature towards the tower.

15. The method of claim 12, wherein the securing comprises coupling a connector of the conveyor mechanism to the first silo, the connector being secured to a chain drive of the conveyor mechanism that is configured to move along a length of the mobile flatbed frame.

16. The method of claim 15, wherein the activating comprises moving the chain drive along the length of the mobile flatbed frame.

17. The method of claim 12, wherein the silo transportation system further comprises a tower positioning mechanism for moving the tower from the first position to the second position.

18. The method of claim 17, wherein the tower positioning mechanism comprises one or more of a telescoping cylinder, a gear and a pulley.

19. The method of claim 12, wherein the silo transportation system comprises one or more stabilizers configured to stabilize at least the mobile flatbed frame.

20. The method of claim 12, further comprising:
pivoting the tower into the second position;
positioning the tower adjacent a second silo;
engaging the moveable attachment feature of the tower with the second silo for releasably securing the second silo to the tower;
moving the movable attachment feature the distance along the tower thereby causing a second base of the second silo to separate from the ground support; and
pivoting the tower into the first position.
